(19) United States
(12) Patent Application Publication
(10) Pub. No.: US 2016/0148108 A1
(43) Pub. Date: May 26, 2016

(54) SOCIAL MEDIA INTELLIGENCE SYSTEM

(71) Applicants: Harry W. Jericho, Valrico, FL (US); Sam G. Stolzoff, Manassas, VA (US)

(72) Inventors: Harry W. Jericho, Valrico, FL (US); Sam G. Stolzoff, Manassas, VA (US)

(21) Appl. No.: 14/950,389

(22) Filed: Nov. 24, 2015

Related U.S. Application Data
(60) Provisional application No. 62/123,652, filed on Nov. 24, 2014.

(51) Int. Cl. G06N 5/04; G06N 99/00

(52) U.S. Cl. CPC G06N 5/047; G06N 99/005

(57) ABSTRACT

An information gathering and intelligence analysis and production system, which in an important version, has a secure interface that aids the user in determining and executing appropriate detailed searches of internet sources such as social media. Results are analyzed and refined to improve the quality of the search results using a wide variety of techniques including intelligence industry analytics. Refined search results may then be further searched and analyzed. Resulting information may be continuously and automatically monitored. Users can select from a variety of reports, predictive analytics, and alert notifications.

### RELATED APPLICATIONS

USPTO provisional patent application No. 62/123,652 filed on 24 Nov. 2014 and titled “Social Media Analytics Software to Facilitate the Discover, Develop, Track (D2 TTM) Methodology” is hereby incorporated in its entirety by reference.

### BACKGROUND OF THE INVENTION

A. Field of the Invention

The system relates to the field of analytics software which produces intelligence products derived from internet and other available sources. The system employs a comprehensive methodology that combines search results from social media data with other data sets so that proven intelligence techniques, analytics and algorithms can better analyze the totality of data now available from a variety of online and hard data sources.

B. Description of the Related Art

There are publicly and privately available information analysis tools that are currently used to analyze social media data sets and other data sets (sources) that allow end-users to enter, search for key words, hashtags, social media user names and other data to see certain trends. Other software tools perform some of the individual functions performed by the invention. However, no existing tool incorporates in an efficient and economical way all of the functions in the invention for use in and analyzing the data-diverse and data-rich requirements of today.

Competing systems have been developed which focus primarily on social media analytics platforms, most of which are designed specifically for providing data for the purpose of marketing, using algorithms and dashboards that seek to enable corporations to increase sales, discover and target new markets, and manage their brand-names online. Most of these platforms seek to use software to process social media data into information that is consumable by end-users for the purpose of marketing. However, they only apply basic analytic techniques to static predefined social media information sets. No known prior art provides for a way to increase the amount and depth of analysis of social media information when it is combined with other data sets and/or to continually track and/or monitor results of such analysis and thereby better enable predicative analytics principles to be applied to the social media data. None of the existing systems suggest the novel features of the present design.

### SUMMARY OF THE PRESENT INVENTION

An important version of the invention includes, among other features, the following processes: (1) combining discovery of relevant data from all the leading social media sources worldwide with other existing data sets; (2) verifying the combined data; (3) analyzing relevant verified combined data; (4) initiating additional discovery of relevant combined data indicated by the initial analyses; and (5) generation of user defined reports, predictions and alerts based upon the combined data for both government and private sectors.

### BRIEF DESCRIPTION OF THE DRAWINGS

With the above and other related objects in view, the invention comprises the details of construction and combination of parts as will be more fully understood from the following description, when read in conjunction with the accompanying drawings in which:

FIG. 1 shows a flow chart of an example of a discover phase of the system.

FIG. 2 shows a flow chart of an example of a develop/analyze phase of the system.

FIG. 3 shows a flow chart of an example of a track phase of the system.

### DETAILED DESCRIPTION OF INVENTION

The subject system and method is sometimes referred to as the device, the invention, the software, the methodology, the process, the tool or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation. Customer sometimes identifies a user of the system. A social media user, user or target sometimes identifies the subject of a search or analysis. The term subjects applies to individual subjects, groups of subjects, networks of subjects and/or subject information content as suggested by context. Subject includes data related to a subject such as identifying information, location, metadata and data related to that subject. Subject is not necessarily human and can include elements in the internet of things (i.e. inanimate things, monitoring devices, data feeds, social media sources, information source and/or data source). The term social media includes social media users, accounts, data and metadata associated with social media platforms. Social media also includes all data sets derived from sources other than those narrowly and only defined as social media. Social media includes any human generated data content and behavior online which is typically from one person to another person or group of persons, but may also include hard data or external data from all available sources, including big data.

In an important version of the system methodology, it begins with a discovery process which allows a user of the system to define, include and combine relevant social media data with other kinds of relevant data sets so the system can then analyze the combined data to produce high quality, useful actionable intelligence for the customer's needs.

An initial step is the construction of either a simple or a complex query of individual or multiple social media platforms utilizing keyword and/or geospatial search parameters. Representative examples of social media platforms could be Facebook, Twitter, Instagram and many others that vary by region. For example, a user can create advanced queries comprising keyword input and/or geospatial search parameters, specifying lexicon, location and activities of interest. Additionally, users have the optional ability to select: keyword translation into selected languages, text analytics parameters which search for closer matches and other parameters to better monitor social media account behavior that correlate to the desired analytical process.

Keywords could include any information selected by the user of the system. For example, keywords might be comprised of individual or combinations of names, events, tags, indexes, locations, symbols, images, terms, numbers, things or profiles. Keywords can be individual items or strings or a combination of items. Keywords could include wildcards, truncators, Boolean or mathematical operators or other means to broaden or narrow a keyword or keywords as needed by the user.

Geospatial parameters generally include any geographical identifiers. By way of example these could include political boundaries such as countries, counties or cities. Geospatial parameters may also be specified by other means, for example, latitude longitude coordinates for an area, a radius from a point, a region or other discretely identified geography. Geospatial parameters may be graphically map based, coordinates, descriptive or other identifiable criteria. For example, the geospatial parameter could be an address, a zone, a place or any other understandable physical location, point or area. A geospatial query may be included in or combined with any other simple or complex query. The geospatial parameter could also include a buffer layer in addition to other geospatial elements.

Geospatial parameters could relate directly to any one or combination of keywords. Geospatial parameters may also be applied to the subject matter of a social media communication. For example, a region may be referred to in a communication or post. Alternatively, the geospatial parameters may define where a message or post originated from or was delivered to. For example, communications from a specific city could be identified in analytic parameters to target keywords originating from or written in that city. Other means and methods to apply specific geospatial locations in an analysis are possible when a user customizes an analysis methodology, execution of a strategy and the resulting information.

An example of a user requirement might be to find a particular person, or to find persons who meet a particular profile. Profiles can be either for government uses such as criminals and kidnappers, or they can be profiles of a particular buyer for particular products. This also could equally apply to a class of buyers or a class of products, as deemed necessary by the user for an analysis. A simple search might consist of just one key word or one name of a selected person. Resulting candidates are displayed to the user from social media accounts and other data sets.

Another example of a case would include a user choosing multiple search parameters (keyword and/or geospatial). A complex query combines several search criteria at the same time. For example, if a car manufacturer was interested in discovering how many people on a social media site or plurality of sites made had an annual income of from $50,000 to $100,000 and who also spent significant time at NASCAR races and who also shopped at Walmart, then a more complex query can be built in the system. The user determines which relevant keywords are necessary to do a search. An example of a more advanced capability is if a customer is only interested in certain income levels of social media users within a certain area. In such cases, the customer can also draw circles, boxes, polygons or other geographic descriptors to further delimit the geographical area of interest. The system can also search for words in other languages which a user can optionally require.

Once the selected social media users of interest and/or other subjects are identified, as described above, the user can review the information, in depth, to discover the “ego networks” centered on each discovered target user. An ego network is defined as the selected person or persons' publicly known, suggested or identifiable relationships. For example, this could be achieved by gleaning direct mentions and/or from their group memberships. For example, a reference to military, religious, professional or industry connections or interests on social media sites, or from other online sources or traditional sources may be useful for establishing a comprehensive and more accurate identification of individual subjects, categories or groupings.

Users can review the content of selected subjects' media content to identify additional subjects and/or matters of interest to the customer. The system can suggest other potential areas of interest by providing tools that aid a user to identify potential user selectable criteria. This is important because interpersonal, organizational, and international social media and other data set connections matter as they transmit behavior, attitudes, information, or goods. This may be important because the original subject or subject group found during searches may lead to additional or other relevant subjects, subject groups and/or subject matter.

If the selected subject is a member of a relevant network of other possible subjects, the system can upload all the possible subjects into a visualization of the related network(s). At each stage the information can be stored. An embodiment of a visualization can essentially be described as a network visualization chart that shows and/or describes known or suspected relationships associated with the subject(s). In this context networks generally indicate a relationship between individuals or subjects. Similarly, groups may have commonalities without any specific relationship. For example, several people in store may be part of a group even when they do not know each other. However, members of a club will more likely have a relationship and would be considered a network.

Users can categorize each social media account as per societal function and can communicate and/or convert search results into public APIs for real time data feed generation. An API is an application protocol interface that essentially coordinates the interface and transfer of data between differing applications. The term API can alternatively include other digital means to connect and communicate with external sources, manipulate data and/or blend dissimilar software applications. Results can also be displayed in chronological order or columns with user customized titles or customized timelines and a variety of user defined graphs, charts and network node maps. Visual representations of social networks can be important to help users better understand network data and convey the result of analyses. Individual or multiple different APIs can be used simultaneously in any analysis or embodiment to enhance visualization abilities and improve communication between dissimilar interfaces or networks.

If the initial search discloses that the selected subject meets the profile of a particular class of subjects, then the system can also determine whether that subject belongs to any groups/networks that also might fit the profile of prospective subjects. Likewise, if the desired profile is that of a criminal, then the same process would apply to discover if he is a member of any such networks of criminals. The operating premise is simply that if a subject is determined to participate or belongs to a particular group then it may be more likely that other members of that group have similar interests, whether those interests are in criminal behavior or in buying pet food.

The methodology also allows the user to include, use, transport, import and export the discovered human or topical network(s) information in various formats to keep a record of their research and results. For example, result formats such as XML, Excel and KML formats.

Additional depth can be obtained by the user who desires to conduct further analysis of resulting information by searching with additional or further refined queries for the members of relevant networks that have been identified.

The system makes additional tools available for the purposes of verifying and/or validating the reliability of the information discovered so far. For example, once additional relevant subjects are identified, the system uses an analysis tool to further determine if the discovered subject is a real person or a bot (fake social media account). This function analyzes frequency of the subject's social media activity because constant frequencies of use may indicate a bot or identify other indicia of unreliability. Irregular frequencies of activity and/or other noted indicia may indicate a higher probability of being generated by a real person and could therefore have an increased probability of value to an analysis.

The methodology also provides the ability for verification and/or validation of target information through identification and analysis of other social media accounts that belong to the selected subject. These accounts are found using additional key word searches, geospatial parameters, natural language processing and using image (picture) searches which incorporate facial recognition techniques.

The system allows the user to further analyze these additional social media accounts and corresponding network visualizations of selected subjects in order to find additional relevant people for the user's purposes. This is done by using techniques such as intelligence analysis techniques including between-ness-centrality, degree-centrality, and Eigenvector nodes. Between-ness-centrality is represented by a score which reflects the subject's connections to other relevant users of social media. Degree-centrality is represented by an actionable score which reflects the closeness of the subject's connections to other relevant users of social media. Eigenvector nodes are represented by a score which reflects the connections of selected subjects to other very connected, and therefore likely relevant, potential additional subjects.

The system also has the option to include behavioral analysis tools and predictive analytics that further analyze the subject and/or subject content. These tools provide specifics regarding personality types, including psycholinguistic profiling of the subject in order to more fully understand his or her perspective, context, and likelihood of future behaviors. Additional behavior analysis tools incorporated in the invention include natural language processing techniques, including for example utilizing artificial intelligence processing. The system optionally also allows users to add comments, notes and analyses of their own as well as to enter third party content regarding selected subjects.

The system allows users to continuously monitor and track selected subjects and subject groups. The user can also create additional folders called group folders or bins. Examples include political, military, economic, social, security, critical infrastructures, income levels, neighborhoods, hobbies, car types, marital status, sports preferences, foul language, drugs, special events, or specific attitudes toward particular projects.

The system can also be continuously monitored by users for online and/or real time results of its analyses of its selected social media users such as individuals, networks, and emerging threats and/or crises. This continuous monitoring allows the system to better create relevant baselines and therefore to spot trends. This facilitates the users' ability to make predictions of increased likelihoods of occurrence of future events and/or behavior. If the predictions require notifications to be sent out, the system can send out automated alerts based on customer defined triggers. Alerts can be on the user's screen or sent via email, text, or similar push technologies to specific users.

The system's reporting component incorporates any or all available information into a choice of automated output mediums. This takes selected results and provides compelling ways to visualize the data, ask questions of the data, and deliver it to users through various means, such as dashboards, reports, and other user selected mechanisms. The system has the capability to create and distribute data in tables, charts and graphs in very specific page layouts. It can produce either print perfect reporting or screen reporting. Print perfect reports can include headers, bands, column formatting, etc. Additionally the system has the capability of displaying all information on mobile devices.

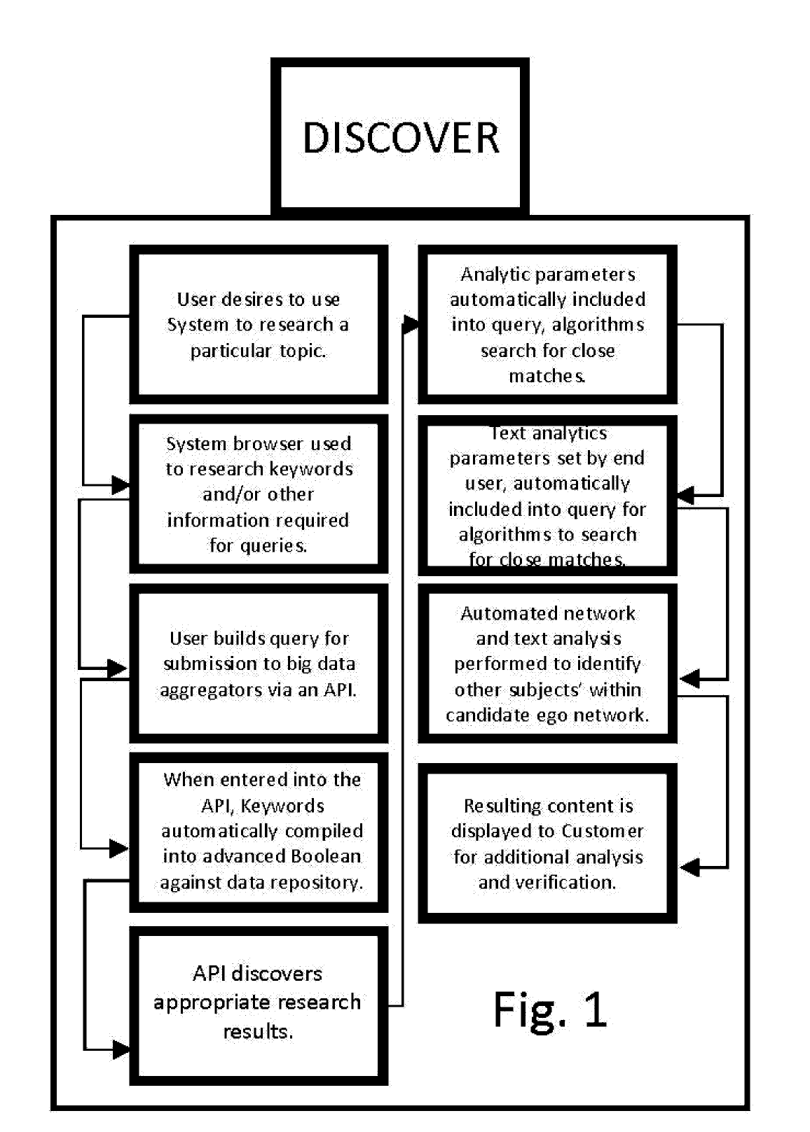

Referring now to the drawings where in FIG. 1 a flow chart is shown demonstrating an example of a discover phase process. This merely an example of an effective version of the system and variations are likely depending on the application and implementation of the system. In the initial step one or more searches are performed across social media platforms seeking social media users and other data sets. Next, the query is expanded by keyword selection and input by the user that may specify query lexicon, location and/or activities of interest. If translation of keywords or other criteria is necessary or desired by the user the system has translation tools available. Additional keywords may be automatically suggested or compiled and advanced Boolean operators may be added and checked against a data repository to improve search quality. Next, the user sets parameters for a social media account and/or other data sets that correlate to which analytics are to be applied against the data sets. Analytic parameters are then automatically turned into query algorithms to search for potential matches. Text analytic parameters are set by the user and automatically included into a query so that algorithms can search for additional close matches. An automated network analysis is performed to identify other potential subjects based on their communications within candidate ego networks utilizing text analytics. The system then results in subjects from social media and other data sets being displayed to the user for more detailed exploration and verification via additional or external means.

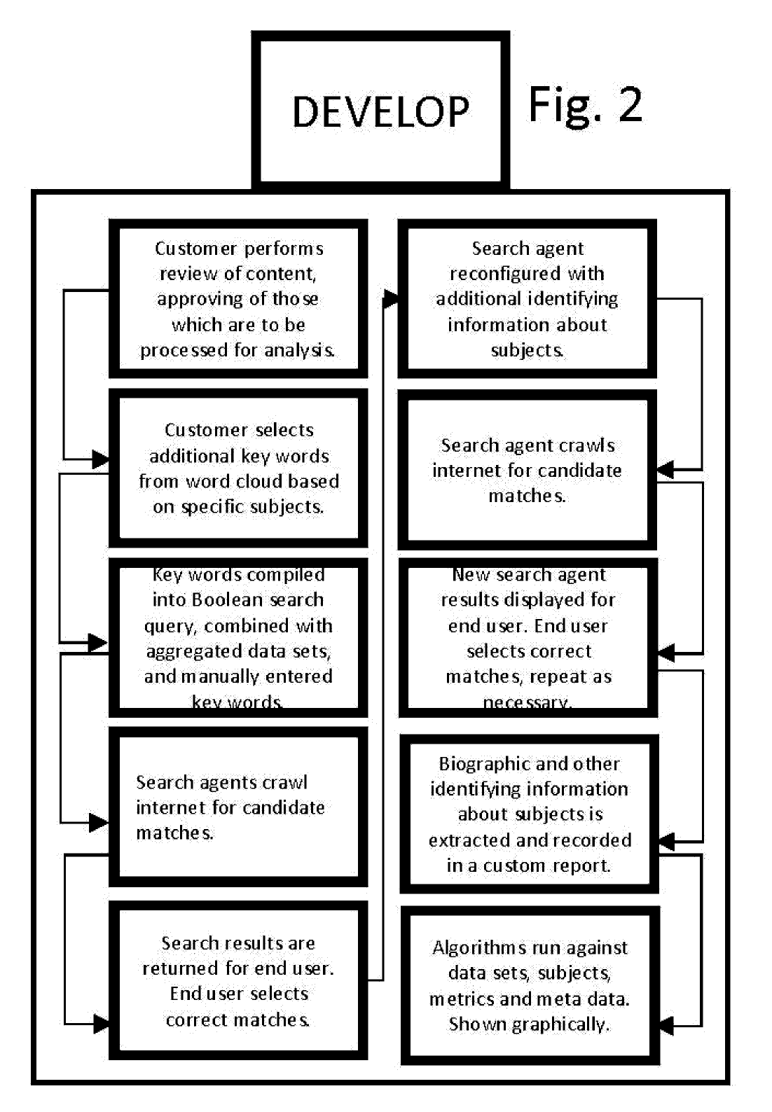

FIG. 2 is a flowchart depicting an example of a development phase. This is an example of an effective method and is illustrating and not limiting. Beginning to develop the information, the user begins by reviewing the individuals and subjects resulting from the discover phase who then approves them for additional development. The user selects key words from a word cloud (or dictionary of terms) based on the social media content specific to that subject. Keywords are then compiled into a Boolean search query and are combined with social media account handles along with manually entered key words that search agents use to crawl the internet for subject/candidate matches. The search results are returned to the user where the user may select specific matches. The search agent may then be reconfigured with any additional identifying information about the subject. Again the search agent crawls the web for more or better subject/candidate matches and displays the results to the user. The user may then manually select matches to further refine the results. This refining loop may be repeated as necessary to improve the results. Biographic and other identifying information relating to a specific subject is extracted, organized, recorded and displayed in a format useful for human understanding. Additional algorithms may be run against web, social media content and other datasets (including but not limited to big data, IOT data and metadata, and results can be graphically displayed.

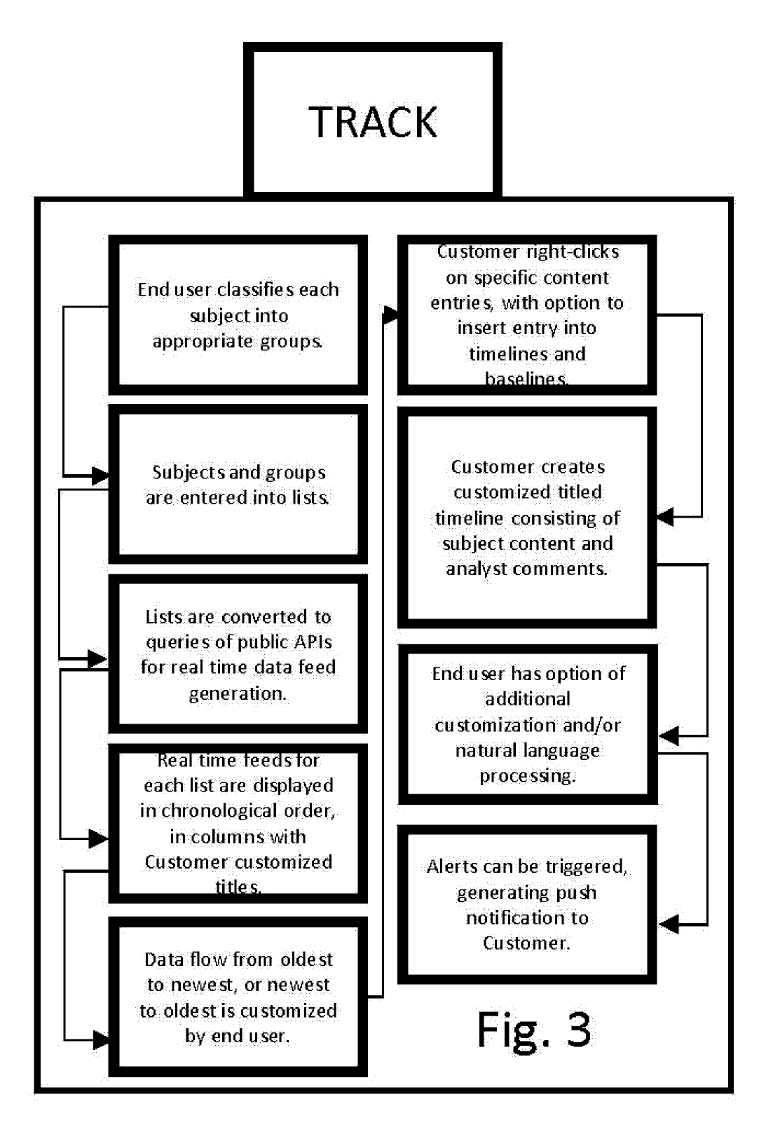

Referring now to FIG. 3 where the track phase of the system is exemplified. This is an effective means but variations are possible that fall within the inventive concept. The track phase may start where the user classifies and lists each subject which has resulted from the development/analytics stage along with any other user inputted data, such as data related to societal function, job function, income parameters, etc. The lists of subjects are communicated and converted to queries of public API's (application protocol interface) for real time data feed generation. The real time feeds for each list may also be displayed in a useable and human understandable format. For example, the display may be columnar and listed in chronological order with user customizable titles or headers. Typically, ordering the data flow from oldest to newest or newest to oldest is customized and utilized for each subject. The user can select a subject entries and can optionally insert that entry into a timeline. The user can customize the timeline relating to a subject including, for example, subject content entries (postings) or manual entries sourced from social media content. The user then may create customized or natural language processing alerts for a particular subject relating to particular events. If the alert criteria is detected then a notice is pushed to the user for appropriate action.

An example of use of the system could be as follows: A user wants to use the system to identify additional sales leads. The user builds relevant queries on the systems dashboard. The query is then submitted to APIs of big data social media aggregators as well as to APIs to relevant data sources. This allows the user to discover data sets which contain additional sales leads who might want to purchase his or her product. The user then employs analytics provided by various APIs to perform analyses selected by the user. As an example, the user is able to identify a number of additional sales leads by leveraging APIs which look at degree and betweenness centrality. The user then queries the systems multiple APIs for even more specific content related to the discovered sales lead. The results of that query are delivered by a communications API into the systems data base. The user has the option of displaying the data in table format. The user can then select the interactions column within the system to identify frequency of contact with other potential sales leads. Lastly, the user can send all data interactions from all sources to an additional analytics API that provides personality insights. With these findings, the user can then better craft a sales capture approach. If further analysis is required, the user can enter the sales lead into a list which initiates additional queries of the previously discovered group of sales leads. Furthermore, the system can monitor selected leads on an ongoing basis in order to allow the user to continuously refine his sales approach.

Another example of use of the system could be as follows: A police detective needs to conduct research on a particular gang. The detective builds relevant queries within the systems anonymous browser which provides access to the public web to identify, for example, names, locations and keywords in order to build a query. The Detective submits those queries on the system via an API to external sources such as social media aggregators, as well as other APIs of relevant data sources. This allows the detective to discover datasets which contain intelligence about additional gang activities, people and related information. The detective then employs analytics provided by various APIs to perform analyses selected by the detective to evaluate the relationship between known gang members and other, possible members and other enablers. As an example, the detective is able to identify a number of additional gang relationships by leveraging APIs which look at degree and betweenness centrality. The detective then queries the systems multiple APIs for even more specific content related to the discovered gang relationships. The results of that query are delivered by a communications API into the systems data base. The detective has the option of displaying the data in table format. The detective can then select the interactions column within the system to identify frequency of contact with other potential gang associates. Lastly, the detective can send all data interactions from all sources to an additional analytics API that provides personality insights. With these findings, the detective can then better craft an investigative approach. If further analysis is required, the detective can enter the gang members into a list which initiates additional queries of the previously discovered group of gang associates. Furthermore, the system can monitor selected gang members and/or associates on an ongoing basis in order to allow the detective to continuously refine his investigative approach.

An important version of the invention can be fairly described as an intelligence production system comprising a discover phase, a develop phase and a track phase, in a single computer based interface. Upon initiating the discover phase of the system a user securely selects a first information from an external source (i.e. raw data or search term) and enters the first information into the interface. The first information could take the form of a wide variety of information of interest. For example, the first information could be a name, a place, a sound, an image or a term. The interface performs a first search securely at a first internet source for the first information producing a first result. The first internet source could be anything on the broad web. For example, it could be a news source, a wiki, a blog, a social media post, a search engine, a database or any other internet source. The first result from the first internet search is recorded by the interface where it can later be accessed. The user evaluates the first result and selects a second information from or related to the first result. The second information is typically found from within the first result but may be otherwise related to the first result. The interface performs a second search at a second internet source for the second information producing a second result. The second internet source could be, but is not necessarily, the same or similar to the first internet source. The second result is recorded by the interface where it can later be accessed. The search can enter a refinement loop and can be repeated to get more, better or different information. Upon initiating the develop phase of the system the user selects a pattern analysis tool. The pattern analysis tool can be integrated within the interface or provided by an external service. More than one tool can be utilized independently, concurrently or consecutively. The interface performs the pattern analysis tool producing a third result. The third result is more accurate information about the subjects of the search, information obtained therefrom and the people and relationships relating thereto. The third result is recorded by the interface where it is later accessible. The third result is comprised of an individual score assigned to each sub element of the second result. Essentially, the score relates to the estimated, known or expected value of each sub-component or element of the second result. The user evaluates manually or with the assistance of the interface the third results and selects from the third result a subset producing a fourth result. This has further improved the quality of the data gleaned into data likely to have significance and worthy of entry into the track phase of the system. Upon initiating the track phase of the system, the interface, at the option of the user, can autonomously and continuously search and/or monitor a third internet source for the fourth result that produces a fifth result. The third internet source may be, but is not necessarily the same as, the first and second internet source. In one version of the system the third internet source is a broad world wide web internet search. The fifth result is generally a located instance of highly relevant information that is likely to be useful to the user. The fifth result is recorded by the interface and is associated with a specific sub element of the fourth result. Essentially the monitored search is associated with a particular entity, individual or data set. The fifth result is processed by a module that performs predictive analysis returning a sixth result. The sixth result may typically be actionable intelligence that is generated by the system with or without interaction from the user.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An intelligence production system comprising a discover phase, a develop phase and a track phase, in a single interface;
upon initiating the discover phase of the system:
a user selects a first information from an external source and enters the first information into the interface;
the interface performs a first search securely at a first internet source for the first information producing a first result;
the first result is recorded by the interface;
the user evaluates the first result and selects a second information from the first result;
the interface performs a second search at a second internet source for the second information producing a second result;
the second result is recorded by the interface;
upon initiating the develop phase of the system;
the user selects a pattern analysis tool;
the interface performs the pattern analysis tool producing a third result;
the third result is recorded by the interface;
the third result is comprised of an individual score assigned to each sub element of the second result;
the user evaluates and selects from the third result a subset producing a fourth result;
upon initiating the track phase of the system:
the interface autonomously and continuously searches a third internet source for the fourth result that produces a fifth result;
the fifth result is recorded by the interface and is associated with a specific sub element of the fourth result;
the fifth result is processed by a module that performs predictive analysis returning a sixth result.

2. The intelligence production system in claim 1 further characterized in that the first, second and/or third internet source is any one or combination of: a social media platform, a public database, a private database, big data, a public directory, a private directory or a hard data source.
